(19) United States
(12) Patent Application Publication
(10) Pub. No.: US 2025/0264021 A1
(43) Pub. Date: Aug. 21, 2025

(54) ESTIMATION OF THE STATIC BULK MODULUS OF A ROCK FROM A PRESSUREMETER TEST

(71) Applicant: Schlumberger Technology Corporation, Sugar Land, TX (US)

(72) Inventors: Richard A. Birchwood, Cambridge, MA (US); Jean Elkhoury, Cambridge, MA (US); Romain Prioul, Cambridge, MA (US)

(21) Appl. No.: 19/054,346

(22) Filed: Feb. 14, 2025

Related U.S. Application Data
(60) Provisional application No. 63/553,754, filed on Feb. 15, 2024.

(51) Int. Cl. E21B 49/00; G01N 3/08

(52) U.S. Cl. CPC E21B 49/006; G01N 3/08; G01N 2203/0075

(57) ABSTRACT

A method including obtaining measurements of one or more first parameters of a packer during an actuation of the packer in a borehole, obtaining measurements of one or more second parameters related to a geometrical change in the borehole caused by the actuation of the packer, and analyzing a plurality of first and second parameters, a plurality of derivatives of the first and second parameters, or a combination thereof to estimate at least a static bulk modulus (K) of a geological formation surrounding the borehole.

### CROSS-REFERENCE TO RELATED APPLICATION

The present application is a U.S. Non-Provisional Patent application claiming benefit of U.S. Provisional Patent Application No. 63/553,754, entitled “STATIC BULK MODULUS ESTIMATION”, filed Feb. 15, 2024, which is herein incorporated by reference in its entirety.

### BACKGROUND

The present disclosure relates generally to systems and methods for static bulk modulus estimation.

The static bulk modulus of elasticity of a rock (K), is an important design parameter in geomechanics. It characterizes the ability of a rock to resist deformation when subjected to compressive stress. It appears, either directly or indirectly in equations governing wellbore stability, hydraulic fracture propagation, reservoir deformation, and sand production. Also appearing in these equations is its companion elastic property known as the static shear modulus of elasticity of a rock, G, which measures the capacity of a rock to resist shear stress. The parameter G can be measured in a borehole using a standard pressuremeter test.

Pressuremeter testing is a well-established technique for measuring soil mechanical properties and stresses with its earliest conceptions dating back to the 1930's. Although it was originally developed for soil or tunneling mechanics applications, there is increasing interest nowadays in using this technique to evaluate rocks in deep subsurface formations relevant to multiple applications such as resources extraction (O&G), fluid storage, CO2 sequestration. The pressuremeter test involves placing a cylindrical (or sometimes cone-shaped) membrane within a borehole, inflating it with a fluid (e.g., oil, water, gas) and recording the pressure-volume (P-V) response as the soil or rock formation is deformed by the tool. Various attributes of the formation are then inferred from this P-V curve. These have included the shear modulus, G, the drained and undrained shear strength, the total horizontal stress, and the coefficient of horizontal consolidation. The soil state parameter can also be measured from which friction and dilation angles could be derived via empirical correlations. The pre-bored pressuremeter device of interest in this application was originally patented by Menard (1960) and can be distinguished from self-boring or pushing-in pressuremeters on the basis that a borehole must be drilled independently before the pre-boring device can be deployed. Pre-bored pressuremeters are also referred to as flexible dilatometers, in contrast to borehole jacks which fall under the category of stiff dilatometers.

A key principle behind standard interpretation of cylindrical pressuremeter tests is that formation properties can be inferred by assuming that the pressuremeter induces uniform radial expansion of an infinitely long cylinder. This makes it possible to apply theories based on the plane-strain assumption, such as elastic cavity theory, to relate soil properties to the measured P-V response. Based on this assumption, the measured formation stiffness (i.e., slope of the pressure versus volume curve) in the elastic deformation regime depends on G and is independent of K. The finite length of pressuremeter devices is regarded to be a complication, which must be corrected for theoretically, or mitigated by using longer packers, as it introduces two-dimensional effects.

However, there is presently no established technique for measuring K in situ. In contrast, the dynamic bulk modulus and dynamic shear modulus are routinely obtained via sonic logging. Moreover, the standard method for measuring K is to extract cores and test them in a laboratory. This is usually time-consuming, expensive, and results may be compromised by damage incurred during coring or subsequent storage of the rock. Therefore, there is a need for a cost and time-saving method or system for measuring K in situ.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In certain embodiments, a method including obtaining measurements of one or more first parameters of a packer during an actuation of the packer in a borehole, obtaining measurements of one or more second parameters related to a geometrical change in the borehole caused by the actuation of the packer, and analyzing a plurality of first and second parameters, a plurality of derivatives of the first and second parameters, or a combination thereof to estimate at least a static bulk modulus (K) of a geological formation surrounding the borehole.

In certain embodiments, a tangible and non-transitory machine readable medium including instructions executable by one or more processors to perform operations including obtaining measurements of one or more first parameters of a packer during an actuation of the packer in a borehole, obtaining measurements of one or more second parameters indicative of a geometrical change in the borehole caused by the actuation of the packer, and analyzing a plurality of first and second parameters, derivatives based on the plurality of first and second parameters, or a combination thereof to estimate at least a static bulk modulus (K) of a geological formation surrounding the borehole.

In certain embodiments, a system including a test tool configured to deploy into a borehole. The test tool includes a packer, a plurality of sensors, and a controller having a processor, a memory, and instructions stored on the memory and executable by the processor. The controller performs operations including obtaining measurements of one or more first parameters of the packer during an actuation of the packer in the borehole via one or more first sensors of the plurality of sensors. The controller also performs operations including obtaining measurements of one or more second parameters indicative of a geometrical change in the borehole caused by the actuation of the packer via one or more second sensors of the plurality of sensors. The controller also performs operations including analyzing a plurality of derivatives associated with the first and second parameters to estimate at least a static bulk modulus (K) of a geological formation surrounding the borehole locally on the controller and/or remotely on a computer separate from the test tool.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an embodiment of a wireline formation tester (WFT) tool in a borehole, illustrating a packer of the WFT tool changing in shape in response to a hydraulic actuation between a deflated configuration and an expanded configuration;

FIG. 2 is schematic of an embodiment of the WFT tool of FIG. 1, illustrating control of the hydraulic actuation of the packer;

FIG. 3 is a schematic of an embodiment of the WFT tool of FIGS. 1 and 2, illustrating a top portion of the WFT tool having the packer in the expanded configuration and a strain and tilt sensor above the packer;

FIG. 4 is a flow chart of an embodiment of a process of determining the static shear modulus (G) and the static bulk modulus (K) using the WFT tool of FIGS. 1-3;

FIG. 5 is a diagram portraying a finite element model of a pressuremeter test using the WFT tool of FIGS. 1-3, in accordance with the present disclosure;

FIG. 6 are two graphs displaying sensitivity tests to determine the effect of (a) the formation shear modulus, G, and (b) the formation bulk modulus (K) on a pressure-volume curve measured during a pressuremeter test using the WFT tool of FIGS. 1-3, in accordance with the present disclosure;

FIG. 7 are two graphs displaying sensitivity tests to determine the effect of the static bulk modulus (K) on a vertical profile of the packer of the WFT tool of FIGS. 1-3. The position of the undisturbed borehole wall is shown for reference (dashed vertical line). The internal pressure in the packer was 30 MPa. (a) Full length packer (L/D ratio=3.4). (b) quarter-length packer (L/D ratio=0.86), in accordance with the present disclosure;

FIG. 8 is a graph displaying a sensitivity test to determine the effect of the static bulk modulus (K) on the circumferential strain of the outermost surface of a quarter-length packer (L/D ratio=0.86). The internal pressure in the packer was 30 MPa, in accordance with the present disclosure;

FIG. 9 is an embodiment of a contour plot of a plurality of contour lines of K and a plurality of contour lines of G as functions of de_{θθ}/dP and dV/dP, enabling a determination of K and G using measurements from the WFT tool of FIGS. 1-3;

FIG. 10 is an embodiment of a contour plot of a plurality of contour lines of de_{zz}/dP and a plurality of contour lines of a dP/dV as a function of K and G, enabling a determination of K and G using measurements from the WFT tool of FIGS. 1-3; and

FIG. 11 is a series of gradient plots illustrating inversion of K and G using the WFT tool of FIGS. 1-3, wherein the plots may be stacked to more precisely estimate K and G, in accordance with the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As mentioned previously, a key principle behind standard interpretation of cylindrical pressuremeter tests is that formation properties can be inferred by assuming that the pressuremeter induces uniform radial expansion of an infinitely long cylinder. The resulting deformation depends only on the radial distance from the borehole centerline, so the problem is reduced to a single dimension (1D). However, in the present disclosure, effects associated with a packer of finite length are exploited to extract the static bulk modulus (K). Explicit recognition is given to the fact that short packers (with length to diameter ratios of less than 1) may be advantageous, because they can, under certain circumstances, increase the sensitivity of the measurement to K. It is shown that K can be inferred if at least one additional metric of deformation or stress besides the P-V curve is incorporated into the inversion scheme for elastic properties. Such metrics include internal or external radii, strain, tilt, or stress of the packer or borehole. The following discussion presents the principles and the process flow to estimate the static bulk modulus (K), of a rock.

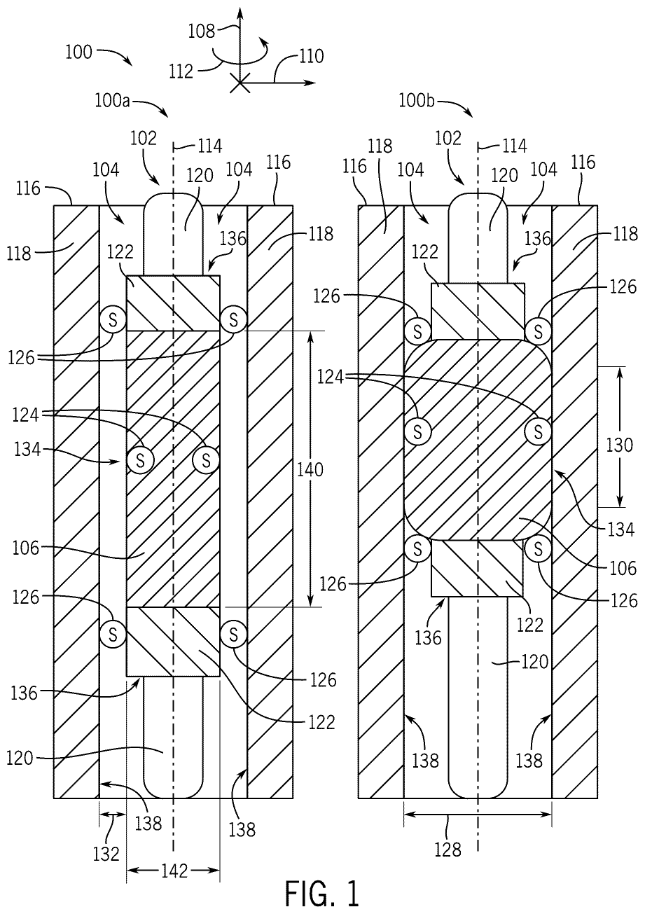

FIG. 1 is a schematic of an embodiment of hydrocarbon extraction system or drilling system 100 having a wireline formation tester (WFT) tool 102 in a borehole 104, illustrating a packer 106 (e.g., annular packer) of the WFT tool 102 changing in shape in response to a hydraulic actuation between a deflated state or configuration 100a and an expanded state or configuration 100b. For purposes of discussion, reference may be made to an axial direction or axis 108, a radial direction or axis 110, and a circumferential direction or axis 112 relative to a central axis 114 of the WFT tool 102. The axial direction 108 may align with the central axis 114 of the WFT tool 102 such that the circumferential axis 112 aligns with the general geometry of the borehole 104. The borehole 104 may be substantially cylindrical and formed from drilling a hole from the surface 116 through one or more geological materials (e.g., rock, clay, etc.) 118. The K values of the geological materials 118 may be measured at a plurality of axial positions in the borehole 104. Further, the borehole 104 may be wide enough to provide clearance 132 (e.g., radial clearance) between the WFT tool 102 and the borehole 104 for deployment to each of the plurality of axial positions prior to hydraulic actuation of the WFT tool 102. The amount of clearance 132 may be based on the amount the packer 106 may expand from the deflated configuration 100a to the expanded configuration 100b, the circumference of the borehole 104, the circumference of the deflated packer 106, and the like.

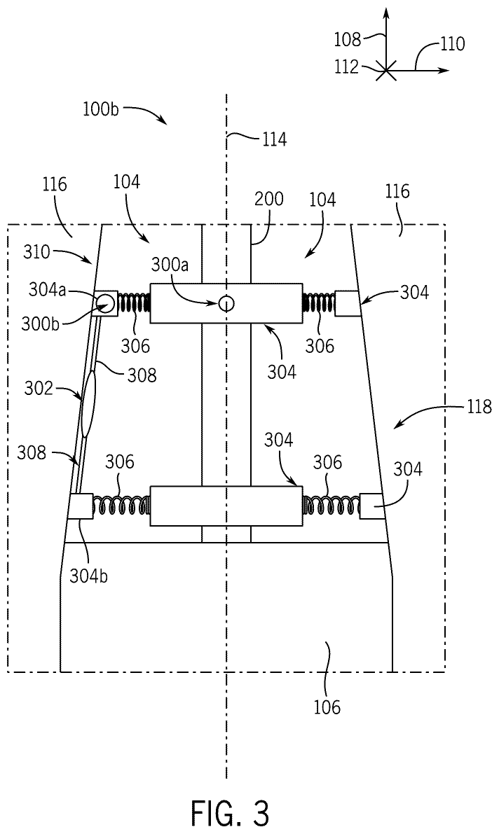

The WFT tool 102 may include a mandrel 120 (e.g., cylindrical mandrel), a sliding coupling 122 (e.g., annular coupling), and the packer 106. The packer 106 may be made of expandable material, such that the packer 106 may expand and exert pressure or deformation stress on the geological material 118 (e.g., geological formation) surrounding the borehole 104. For example, the packer 106 may include an annular wall or body made of an elastomeric material, which expands in response to a hydraulic pressure applied to an internal hydraulic chamber. The WFT tool 102 includes one or more sensors 124 (e.g., packer sensors, internal sensors) coupled to and/or integrated within the packer 106 to measure one or more parameters, such as pressure, deformation, stress, packer volume, strain or stress of the packer, internal radii, external radii, or a combination thereof. The sensors 124 may measure the one or more parameters at one or more points in the expansion process from the deflated configuration 100a to the expanded configuration 100b. In certain embodiments, the parameters may include tangential and/or circumferential strain (see), pressure (P), and volume (V) of the packer 106 during the expansion process. In certain embodiments, the WFT tool 102 may further include sensors 126 (e.g., external sensors) outside and/or separate from the packer 106, but inside the borehole 104, and configured to measure various parameters indicative of the geometry (e.g., radius, tilt angle, strain, etc.) of the borehole wall 138. These sensors 126 are discussed in more detail in FIG. 3. The sensors 124 and 126 may be disposed in a plurality of axial positions along the axial axis 108, a plurality of radial positions along the radial axis 110, and a plurality of circumferential positions about the circumferential axis 112 of the WFT tool 102. Each of the illustrated sensors 124 and 126 may include any of the sensors described in detail herein.

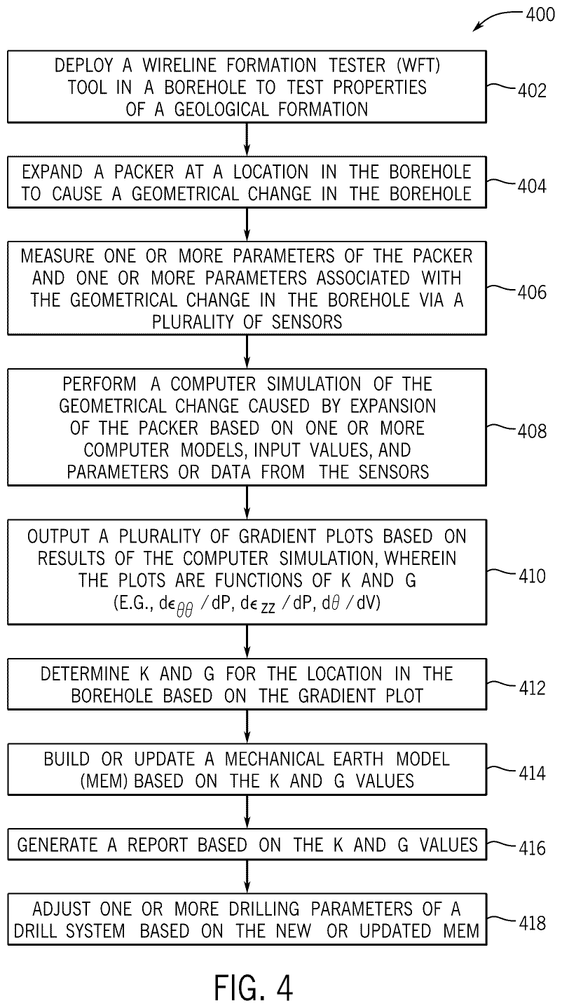

In some embodiments, the WFT tool 102 includes the sensors 124 in one or more locations around the circumference of a leading edge 134 of the packer 106 during the expansion process from the deflated configuration 100a to the expanded configuration 100b. The leading edge 134 of the packer 106 may be defined as the position (e.g., axial position along the axial axis 108 and radial position along the radial direction 110) about the circumference (e.g., in the circumferential direction 112) of the packer 106 making first contact with the inner circumference of the borehole 104 during the expansion process as the packer 106 radially expands in the radial direction 110. For example, for a symmetrical configuration of the packer 106, the leading edge 134 may be located midway (e.g., axial center point) along an axial length of the packer 106. In certain embodiments, the WFT tool 102 includes the sensors 124 at one or more axial positions along the axial axis 108 of the packer 106. For example, the sensors 124 may be disposed at the axial position of the leading edge 134 and/or a plurality of axial positions (e.g., increments of 5, 10, 15, or 20 percent) along an axial length of the packer 106. The acquisition of sensor data from sensors 124 at one or more axial positions along the axial axis 108 of the packer 106 may provide more data to assist the computer model further described below in the description of FIG. 4.

As the packer 106 expands in the radial direction 110, the clearance 132 between the packer 106 and the borehole 104 gradually decreases until the packer 106 contacts and applies a force to the inner circumference of the borehole 104. The sensors 124 and 126 of the WFT tool 102 record data relating to the packer 106 and the geometry of the borehole wall 138 before, during, and/or after the expansion process as the packer 106. The sensors 124 and 126 may directly contact the packer 106 and/or the geological material 118, indirectly coupled with an inner circumference of the borehole 104 via structural portions of the WFT tool 102, or a combination thereof. The expanded packer 106 may have a shorter expanded height 130 than the deflated height 140. Further, the expanded packer 106 may have a wider expanded diameter 128 than the deflated packer 106. As the packer 106 inflates, the sliding coupling 122 may slide over the mandrel 120, so the opposing axial ends 136 of the packer 106 are closer to each other along the axial axis 108. When deflated, the packer 106 may have a deflated length (e.g., height) 140 to deflated diameter 142 (L/D) ratio between 2.5 and 4. Conversely, when the packer 106 is fully expanded, the L/D ratio of the packer may be less than 1. However, the L/D ratio may vary in various embodiments of the WFT tool 102 and deployments in a borehole 104. In some embodiments, the WFT tool 102 may exclude the sliding coupling 122, position the sliding coupling 122 on the opposite axial end 136 of the packer 106, and/or include other embodiments of the packer 106. As discussed in detail below, the measurements by the sensors 124 and 126 may be used by the WFT tool 102 to determine various parameters of the geological material 118, including the static bulk modulus (K) and the shear modulus (G).

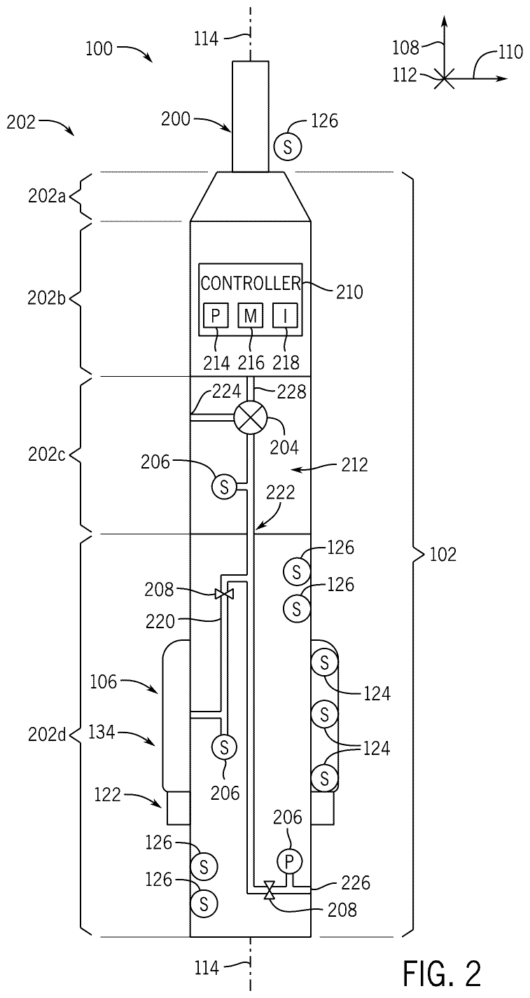

FIG. 2 is a schematic of an embodiment of the WFT tool 102 on a line 200. The WFT tool 102 and line 200 extend along the central axis 114. In certain embodiments, the line 200 may include a conduit or a wireline. The WFT tool 102 may include the packer 106, the one or more sensors 124, the one or more sensors 126, and the sliding coupling 122, as discussed in the description of FIG. 1. Further, the WFT tool 102 may include a plurality of tool sections 202, including a cap section 202a, a controller section 202b, a pump section 202c, and a packer section 202d. Each of the tool sections 202 may include an annular body portion housing and/or supporting components of the WFT tool 102. For example, the controller section 202b includes a controller 210, the pump section 202c includes one or more pumps 204 and fluid sensors 206, and the packer section 202d includes the packer 106, the one or more sensors 124 and 126, one or more valves 208, and one or more fluid sensors 206. In the illustrated embodiment, the WFT tool 102 includes a fluid circuit 212 (e.g., hydraulic fluid circuit) extending at least through the pump section 202c and the packer section 202d in fluid communication with the pump 204, the fluid sensors 206, the valves 208, and the packer 106. The controller 210 has a processor 214, a memory 216, and instructions 218 stored on the memory 216 and executable by the processor 214 to control various components of the WFT tool 102. The controller 210 is configured to monitor sensor feedback from the sensors 124 and 126 and the fluid sensors 206 and control the pump 204 and the valves 208 to operate an expansion process of the packer 106. Additionally, the controller 210, a remote controller, and/or a remote computer system is configured to analyze the sensor feedback from the sensors 124 and 126 to determine various parameters of the geological material 118, including the static bulk modulus (K) and the shear modulus (G) as discussed in further detail below.

In the illustrated embodiment, the fluid circuit 212 includes fluid passages 220 and 222 for hydraulically actuating the packer 106. The fluid passage 222 extends through the WFT tool 102 between fluid ports 224 and 226 in fluid communication with the borehole 104. In some embodiments, the fluid passage 222 is coupled to a supply fluid passage 228 extending through the WFT tool 102 and/or the line 200 to a fluid supply, such as a fluid supply tank. However, in the illustrated embodiment, the controller 210 is configured to execute an expansion process of the packer 106 by closing the valve 208 adjacent the fluid port 226, opening the valve 208 along the fluid passage 220, and operating the pump 204 to pump a wellbore fluid (e.g., used as a hydraulic fluid) through the fluid passages 220, 222 to the packer 106 to expand the packer 106 in the radial direction 110 as discussed above with reference to FIG. 1. Upon complete expansion of the packer 106, the controller 210 may close the valve 208 along the fluid passage 220 to retain fluid pressure in the packer 106 to hold the expanded configuration of the packer 106. During the expansion process, the fluid sensors 206 may monitor various parameters of the fluid supplied to the packer 106, including but not limited to a pressure, a temperature, a flowrate, or any combination thereof. Thus, the fluid sensors 206 may include pressure sensors, temperature sensors, flow rate sensors, or any combination thereof. Additionally, during the expansion process, the sensors 124 may monitor various parameters of the packer 106, such as the tangential strain (Eee), axial strain (Ezz), pressure (P), and volume (V) of the packer 106 as discussed above with reference to FIG. 1. The sensors 126 may further monitor parameters of the borehole 104 and/or the geological material 118 before, during, and/or after the expansion process, such as the radius or diameter, the tilt, the deformation, and/or any geometrical parameters of the borehole 104 adjacent the packer 106. Similarly, the controller 210 is configured to execute a contraction process of the packer 106 by opening the valve 208 adjacent the fluid port 226 and opening the valve 208 along the fluid passage 220, thereby enabling the fluid to vent into the borehole 104 via the fluid ports 224 and/or 226 and enabling the packer 106 to contract in the radial direction 110. In some embodiments, the static bulk modulus (K) and the static shear modulus (G) may be determined based on the measurements by the sensors 124 and 126 before, during, and/or after the expansion process, the contraction process, or a combination thereof.

FIG. 3 is a schematic of an embodiment of the WFT tool 102 of FIGS. 1 and 2, illustrating a top portion of the WFT tool 102 in the borehole 104 with the packer 106 in the expanded configuration and a plurality of sensors 126 separate from the packer 106. The WFT tool 102 is substantially the same as discussed in detail above with reference to FIGS. 1 and 2, and thus like element are shown with like numbers. Additionally, the illustrated sensors 126 are shown above the packer 106, although embodiments of the WFT tool 102 may include the sensors 126 above and/or below the packer 106. The sensors 126 may be disposed directly adjacent to the packer 106 within an axial distance suitable to obtain geometrical parameters of the borehole 104 directly adjacent to the packer 106. In the illustrated embodiment, the sensors 126 include a tiltmeter 302, and strain sensors 300 (e.g., strain gauges) embedded within an extensometer tool 310. However, in some embodiments, the sensors 126 may include any one or more strain sensors 300, tiltmeters, caliper tools, extensometer tools, piezo sensors, sonic and ultrasonic sensors, or any combination thereof, to measure changes in the geometry of the borehole 104 directly along and/or adjacent the packer 106. Thus, this disclosure is not merely limited to those sensors 126. Indeed, high-precision caliper tools, strain gauges attached to the borehole wall 138, tiltmeters situated inside the packer 106, multiple extensometer anchor points, and other stress, strain, or displacement measuring tools may be used as part of the WFT tool 102.

As illustrated in FIG. 1, the borehole 104 is formed as a hole in geological material 118. In the illustrated embodiment, the borehole 104 is no longer a cylindrical geometry, but rather is sloped inside near the expanded packer 106 as a result of the packer's 106 expansion. As such, the use of a tiltmeter 302 to gauge the tilt of the borehole 104 above the packer 106 may be useful to determine more properties of the geological material 118. Correspondingly, the extensometer 310 may measure the strain at two different axial positions along the axial axis 108 above the packer 106, below the packer 106, or both. The strain at varying axial distances from the packer 106 may indicate deformation of the geological material 118, which may be indicative of the static bulk modulus (K) of the geological material 118.

The extensometer 310 may include spring-loaded clamps 304 extending radially to anchor the tool to the borehole wall 138. In some embodiments, the clamps 304 may be less than 10 centimeters apart. When the clamps 304 are close to the top of the packer 106, the tiltmeter 302 and the extensometer 310 may more accurately detect displacements of the borehole wall 138.

The tiltmeter 302 may be coupled to a rod 308 which connects the tiltmeter 302 to both clamps 304. The tiltmeter 302 may measure the tilt of the meridian of the borehole wall 138 between the clamps 304.

As the packer 106 is inflated to the expanded configuration, a depression is created in the borehole 104, which persists for some distance above and below the packer 106. The change in the angular orientation of the meridian of the borehole wall 138 is monitored by the tiltmeter 302. The borehole wall 138 also stretches to accommodate the packer 106. This axial strain is conveyed to strain sensors in the extensometer 310 by rods such as 308. As such, the tiltmeter 302 and the strain sensors 300a, 300b are able to determine displacement of the borehole wall 138, which may be indicative of one or more properties of the geological material 118. As discussed in detail below, the measurements by the sensors 126 (e.g., strain sensors 300 and tiltmeter 302) may be used by the WFT tool 102 to determine various parameters of the geological material 118, including the static bulk modulus (K) and the shear modulus (G).

FIG. 4 is a flow chart of an embodiment of a method 400 of estimating the static bulk modulus (K). At block 402, the system may deploy a wireline formation tester (WFT) tool 102 in a borehole 104 to test properties of a geological formation. The properties of a geological formation may be properties of the geological material 118, such as composition, temperature, moisture content, and the like. The properties of a geological formation may also include the structure of the formation, density of the formation, and any other information helpful to constructing a geomechanical model of the earth known as a mechanical earth model (MEM).

At block 404, the system may expand a packer 106 at a location in the borehole 104 to cause a geometrical change in the borehole 104. The packer 106 may expand in a substantially similar manner to that described in FIGS. 1-3. Specifically, as the packer 106 expands in the radial direction 110, an annular outer surface of the packer 106 may press into the geological material 118, which may deform in different ways and to different degrees based on the geological properties of the geological material 118 and the borehole 104.

Next, at block 406, the system may measure one or more parameters of the packer 106 and one or more parameters associated with a geometrical change in the borehole 104 via a plurality of sensors 124 and/or 126. In some embodiments, the system may measure both the parameters associated with the packer 106 and the parameters associated with a geometrical change with the sensors 124 alone. The sensors 124 may be substantially similar to those described in FIGS. 1 and 2. As such, the sensors 124 may measure packer volume (V), packer pressure (P), tilt within the packer, tangential packer strain (ε_{θθ}), and/or axial packer strain (ε_{zz}). In some embodiments, the sensors 124 may be located at the leading edge 134 of the packer 106, a plurality of axial positions along the axial length of the packer 106, and/or a plurality of circumferential positions about a circumference of the packer 106. By increasing the number and/or varied positions of the sensors 124, the method 400 may increase the accuracy of measurements and the determination of the K and G values.

In some embodiments, the system may measure the parameters associated with the packer 106 using the sensors 124 and the parameters associated with a geometrical change with the sensors 126. While the composition, capabilities, and embodiments of the sensors 124 as described above applies in this embodiment as well, the system may also utilize sensors 126 to measure more geological and geometric properties of the borehole 104 as described with reference to FIGS. 2 and 3. The sensors 126 may include a tiltmeter, a strain sensor, and extensometer, and any other high precision sensors capable of sensing the geometry of the borehole 104. Thus, the sensors 126 may provide additional data for use along with the data from the sensors 124, which may provide higher precision K and G values. Additionally, the sensors 126 may be disposed at a plurality of axial positions above and/or below the packer 106 and/or a plurality of circumferential positions about a circumference of the borehole 104. By increasing the number and/or varied positions of the sensors 124, the method 400 may increase the accuracy of measurements and the determination of the K and G values.

At block 408, the system may perform a computer simulation of the geometrical change caused by expansion of the packer 106 based on one or more computer models, input values, and measurements from the sensors 124, 126. The computer simulation may utilize sensor parameters or data acquired from the sensors 124 and/or the sensors 126. Further, the computer simulation may utilize a series of constant values based on the location of the borehole 104, such as the temperature, soil moisture, borehole diameter, and the like. The user may also input a range of potential K and G values at the locations of the sensors. The ranges of K and G input into the computer simulation may be based on the location of the borehole and the potential K and G values of the geological material 118 in the borehole 104. The computer simulation may further perform error analysis on its results to eliminate any faulty data from its calculations to more precisely and accurately provide results.

The computer simulation may include a semi-analytical scheme designed to approximate loading the packers by imposing a uniform axisymmetric pressure (P), over a depth interval (L_{c}) of a borehole wall. The semi-analytical scheme may utilize equations such as:

$$u = [ \frac{3 m - 4}{m} f ( x ) - x {f}^{′} ( x ) - {g}^{′} ( x ) ] cos βζ \qquad ( 1 )$$

$$w = [ x f ( x ) + g ( x ) ] β sin βζ \qquad ( 2 )$$

$$\frac{d}{4 G} {σ}_{rr} = [ \frac{3 m - 2}{m} {f}^{′} ( x ) - ( {β}^{2} x + \frac{m - 2}{m x} ) f ( x ) + \frac{{g}^{′} ( x )}{x} - {β}^{2} g ( x ) ] cos βζ \qquad ( 3 )$$

$$\frac{d}{4 G} {τ}_{r z} = [ x {f}^{′} ( x ) - \frac{m - 2}{m} f ( x ) + {g}^{′} ( x ) ] β sin βζ \qquad ( 4 )$$

where u and w are the radial and axial displacements, respectively, σᵣᵣ and τ_{rz} are normal and shear stresses, respectively, m is the inverse of the static Poisson's ratio of the rock, G is the static shear modulus of the rock, x and ζ are normalized coordinates equal to 2r/d and 2z/d, respectively. Further, d is the borehole diameter, r is the radial coordinate, z is the axial coordinate, and β is the wavenumber in the z-direction.

Additionally, f(x) and g(x) may be computed using f(x)=C₂K₁(βx) and g(x)=D₂K₀(βx), respectively. In the foregoing equations, K₀(βx) and K₁(βx) are both modified Bessel functions. C₂ and D₂ may be constants determined by applying constant pressure and appropriate slip boundary conditions to the borehole wall via Equations 3 and 4 above. For example, no slip boundary conditions may be applied by assuming that τ_{rz}=0. Furthermore, m may be expressed as

$$m = \frac{2 ( 3 K + G )}{3 K - 2 G} .$$

Equations (1)-(4) above represent solutions for a single wavenumber β. General solutions are found by integrating Equations (1)-(4) over all real and positive values of β. This can be achieved most efficiently using discrete sine and cosine transforms.

Once the displacements u and w are determined, the deformed geometry of the borehole wall can be found and strains at any location on the borehole wall can be computed. The volume of the depression produced by loading can be used to estimate the change in the volume of the packer, ΔV, assuming minimal expansion of the packer in the axial direction. The inputs to the scheme are K, G, d, P, L_{c}, and the z-coordinates of sensors in contact with the borehole wall. The outputs are u and w at sensor locations, along with ΔV. The outputted values of u and w can be used to estimate strains and tilt angles at sensor locations on the borehole wall. When numerical or graphical inversion is performed (as will be discussed in relation to FIG. 4), strains, tilt angles, ΔV or derivatives contructed from these three quantities become the inputs and K and G become outputs.

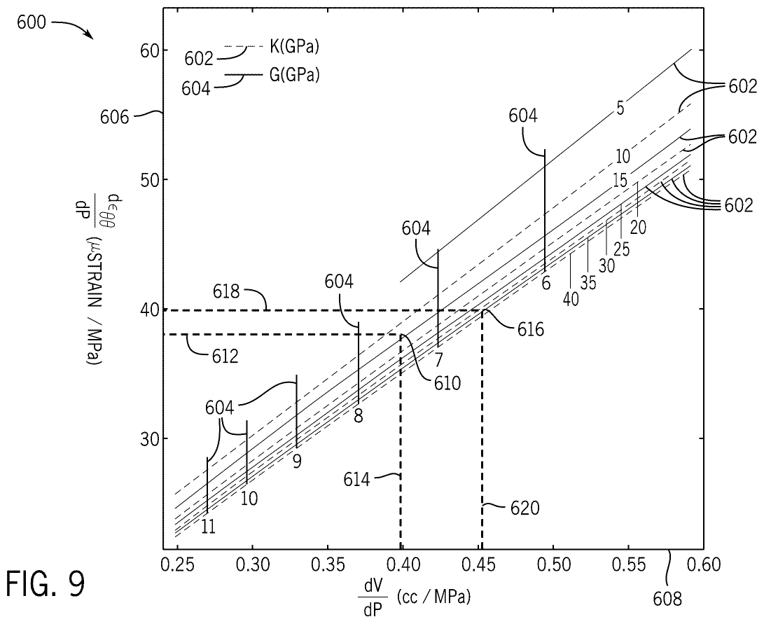

At block 410, the system may use the results of the computer simulation to output a plurality of contour plots. The contour plots may be functions based on the data accumulated by the sensors 124 and/or 126. As such, the axes may be the derivative of the tangential strain with respect to the pressure (dε_{θθ}/dP) (μStrain/MPa) for the sensors above the packer 106, on the surface of the packer 106, and/or below the packer 106, the derivative of the axial strain with respect to the pressure (dε_{zz}/dP) (μStrain/MPa) for the sensors above the packer 106, on the surface of the packer 106, and/or below the packer 106, the derivative of the tilt with respect to the volume (dθ/dV) (arcSec/cc) for the sensors above the packer 106, on the surface of the packer 106, and/or below the packer 106, the derivative of the volume with respect to the pressure (dV/dP) (cc/MPa), and the like. The plot may include contour lines of K and G, as illustrated further in FIG. 9.

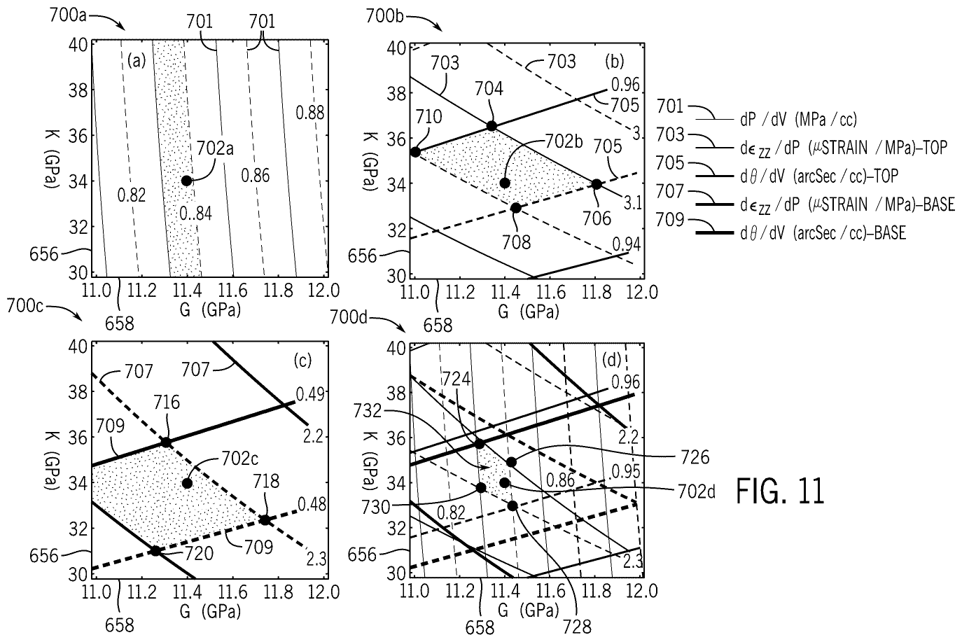

In some embodiments, the contour plots may be inverted. Specifically, the contour plots may be functions of K and G, in which K values are plotted on the Y axis and G values are plotted on the x axis. As such, the contour lines on the contour plot may be the derivative of tangential strain with respect to pressure (dε_{θθ}/dP) (μStrain/MPa) for the sensors above the packer 106, on the surface of the packer 106, and/or below the packer 106, the derivative of axial strain with respect to the pressure (dε_{zz}/dP) (μStrain/MPa) for the sensors above the packer 106, on the surface of the packer 106, and/or below the packer 106, the derivative of tilt with respect to the volume (dθ/dV) (arcSec/cc) for the sensors above the packer 106, on the surface of the packer 106, and/or below the packer 106, the derivative of pressure with respect to the volume (dP/dV) (MPa/cc), and the like. The system may overlay one or more inverted contour plots to more precisely determine the K and G values for the geological material 118 in the borehole 104. This process is described further in the description of FIG. 11.

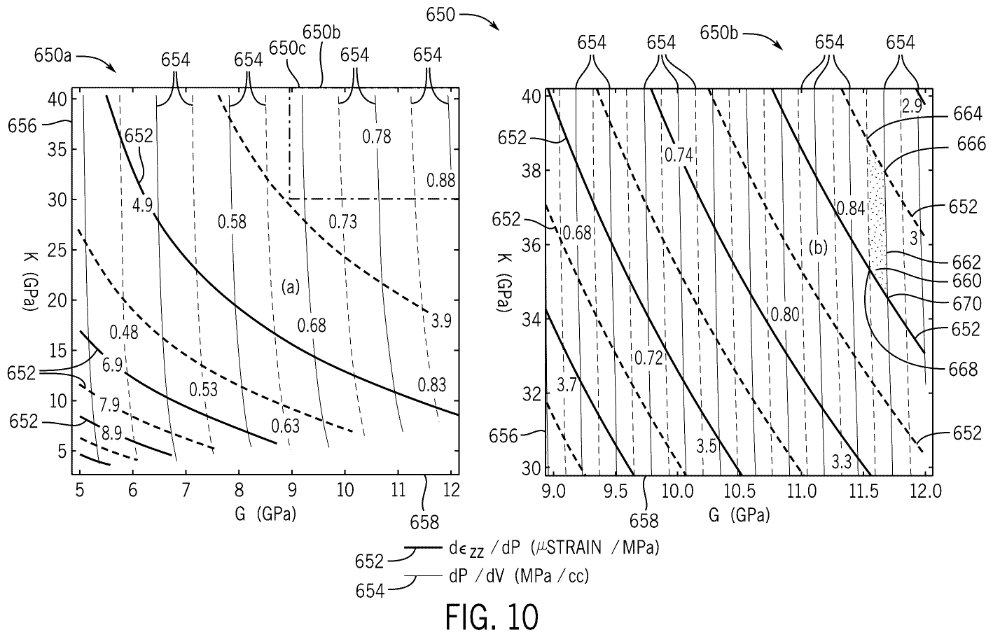

At block 412, the system may use the contour plots from block 410 to determine K and G for the location in the borehole. The method of utilizing the contour plot may be based on contour plots with either measured data or inferred parameters on its axes and correspondingly, inferred parameters or measured data plotted as contours. For purposes of this discussion the former plot will be referred to as a “standard contour plot” whereas the latter shall be referred to as an “inverted contour plot”. Using the standard contour plot, the system may select the point on the K and G contour lines that best aligns with the derivative of tangential strain with respect to the volume (dε_{θθ}/dV) (μStrain/MPa) and the derivative of volume with respect to the pressure (dV/dP) (cc/MPa) measured from the sensors at the designated location in the borehole 104. In other embodiments, other measurements as described above may be used in place of the derivative of tangential strain with respect to the pressure (dε_{θθ}/dP) (μStrain/MPa) and the derivative of volume with respect to the pressure (dV/dP) (cc/MPa). These alternatives are further described below in the description of FIG. 10.

In embodiments utilizing an inverse plot with values of K and G on its axes, the system may overlay one or more contour lines of the derivative of tangential strain with respect to the pressure (dε_{θθ}/dP) (μStrain/MPa) for the sensors above the packer 106 and/or below the packer 106, the derivative of the axial strain with respect to the pressure (dε_{zz}/dP) (μStrain/MPa) for the sensors above the packer 106 and/or below the packer 106, the derivative of the tilt with respect to the volume (dθ/dV) (arcSec/cc) for the sensors above the packer 106 and/or below the packer 106, the derivative of the pressure with respect to the volume (dP/dV) (MPa/cc), and the like. Once the contour lines are overlaid, the system may use the contour lines to identify a region between the contour lines. The region may provide the system with K and G values, within a certain margin of error. For example, the contour lines may provide a region where the highest possible K value is 36 GPa and the lowest possible K value is 31 GPa. As such, the system may use this range as the range of possible K values based on the data obtained by the sensors 124 and sensors 126. This process is further described below in the description of FIG. 11.

At block 414, the system may build a mechanical earth model (MEM) based on the K and G values. The MEM may be a repository of data representing the mechanical properties of geological material 118 (e.g., rocks) and fractures as well as the stresses, pressures, and temperatures existing in them at depth. Each data point in an MEM is referenced to its spatial coordinates (e.g., three-dimensional coordinates) and time. The measurements included in a MEM may include the magnitude of the vertical stress, the magnitude of the minimum horizontal stress, the magnitude of the maximum horizontal stress, the pore pressure, the K value, the G value, and the like. The MEM may include measurements accounting for the effects of reservoir fluids accumulated over geologic history, cumulative present-day hydrocarbon extraction, fluid injections to stimulate recovery, gravity, and the far-field tectonic stresses. The accuracy of the MEM may generally increase as more data measured by the sensors 124 and sensors 126 is acquired and used by the method 400. The availability of K and G values through the disclosed method may provide faster methods of building a MEM model than traditional methods, as traditionally, the MEM model may have to wait days for a laboratory to test samples of geological material 118 from the borehole 104 to acquire values of K and G.

In some embodiments, the system may update a mechanical earth model (MEM) based on the K and G values. Indeed, if a MEM already exists for that location in the borehole, but new K and G values become available, the new K and G values may be used to update the MEM model. These updates may increase the efficiency and safety of drilling, as the most up-to-date MEM model may more accurately inform well operators of relevant changes in borehole conditions which may encourage adjustments in well operation.

At block 416, the system may generate a report based on the K and G values. The report may be a notification the system may send to an electronic display of an electronic device (e.g., processor-based device or computer) to inform the operator of the estimated K and G values. Further, in some embodiments, the report may include one or more interactive plots from block 410 and block 412. The user may view the contour plots, invert the contour plots, remove any overlays to individually view the contour plots, and the like. In some embodiments, the report may include one or more recommended adjustments to the drilling parameters based on the determined K and G values.

Additionally, the system may, at block 418, adjust one or more drilling parameters of a drill system based on the new or updated MEM. The drilling parameters may include adjustment of the mud weight based on the MEM, design a drilling job based on the MEM, and the like. The MEM may be used to increase drilling safety, prevent sanding, design a CO₂ injection system, design a hydraulic fracturing system, and the like. As the MEM is created or updated, operational parameters may adjust to fit the MEM. In other embodiments, the MEM may adjust other parameters based on the MEM and the needs of the system. For example, if the system is a CO₂ injection system instead of a drilling system, the system may adjust injection parameters. In some embodiments, the users may manually adjust the relevant parameters. In other embodiments, the system may automatically adjust the parameters based on the MEM and the system's target operation.

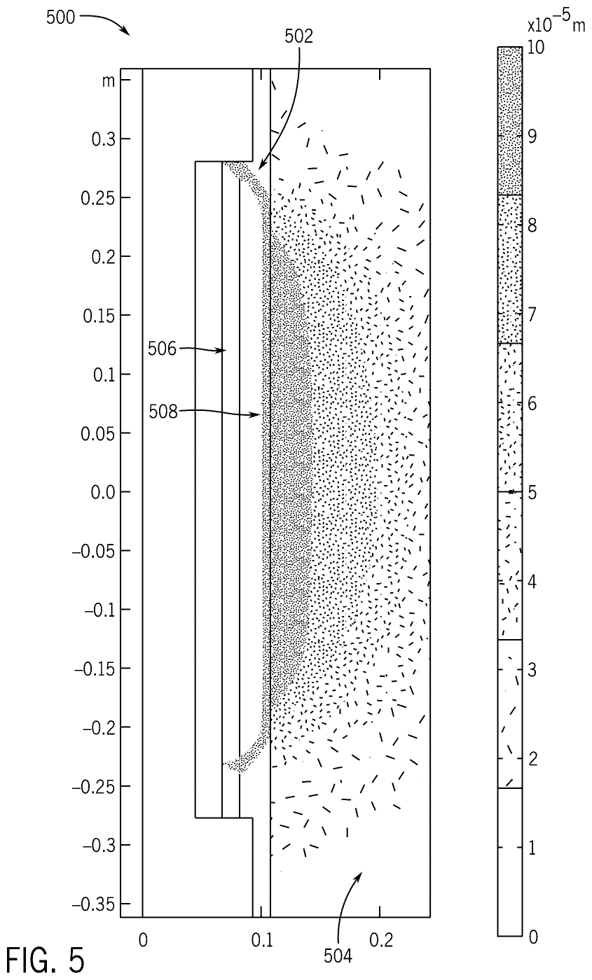

Finite-element simulations of the pressuremeter test in a vertical borehole were performed to evaluate the sensitivity of various measurements to the static bulk modulus (K). FIG. 5 shows a snapshot 500 of a vertical cross-section through the axisymmetric model. The packer 106, which includes a rubber membrane 502 mounted on a steel mandrel 506, has been expanded to contact the formation by applying an internal pressure of 30 MPa. No other pressures or stresses are applied to the model. In this example, the initial length to diameter ratio of the packer is 3.4. The bulk and shear moduli of the formation are 8.3 GPa and 9.1 GPa, respectively. The radial displacements induced in the geological formation 504 by contact with the packer are superimposed on the formation. Displacements of the order of 100 μm can be seen at the borehole wall. As illustrated, the displacement is the greatest at the leading edge 508 of the rubber membrane 502.

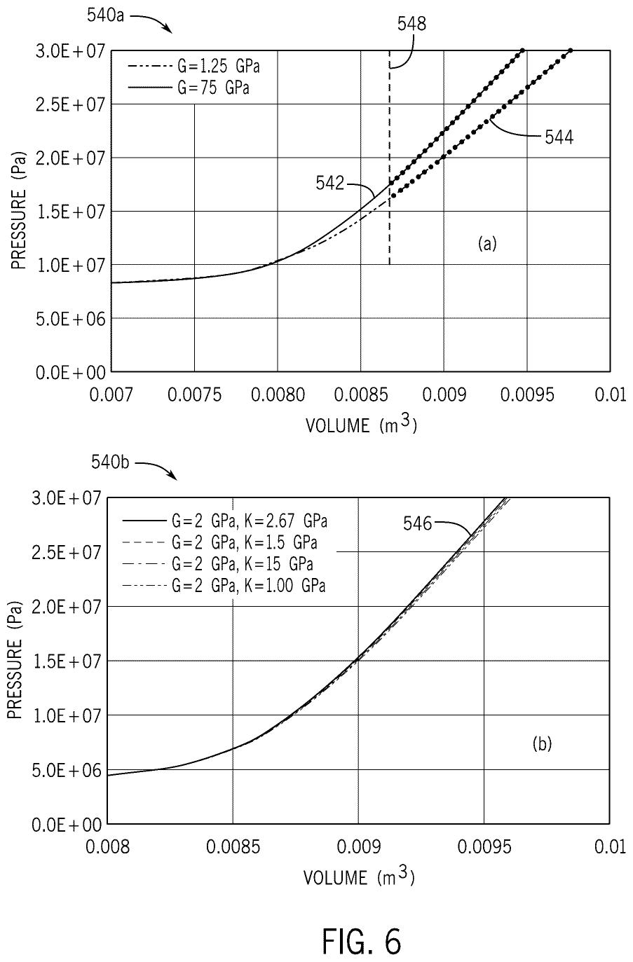

FIG. 6 shows sensitivity tests 540a, 540b run using the finite-element model, to determine the influence of the shear and bulk moduli on the P-V curve (542, 546). As illustrated, the slope dP/dV, is initially small and then increases dramatically as the packer 106 contacts the borehole wall. As shown in 540a, eventually the slope stabilizes when the volume lies beyond the vertical cutoff line 548. This stabilized slope can be directly related to the elastic stiffness of the formation. The extraction of this slope is shown in sensitivity test 540a. It is evident that the final slope 544 is highly sensitive to G. In contrast, sensitivity test 540b demonstrates that the slope is highly insensitive to the bulk modulus of the formation (K).

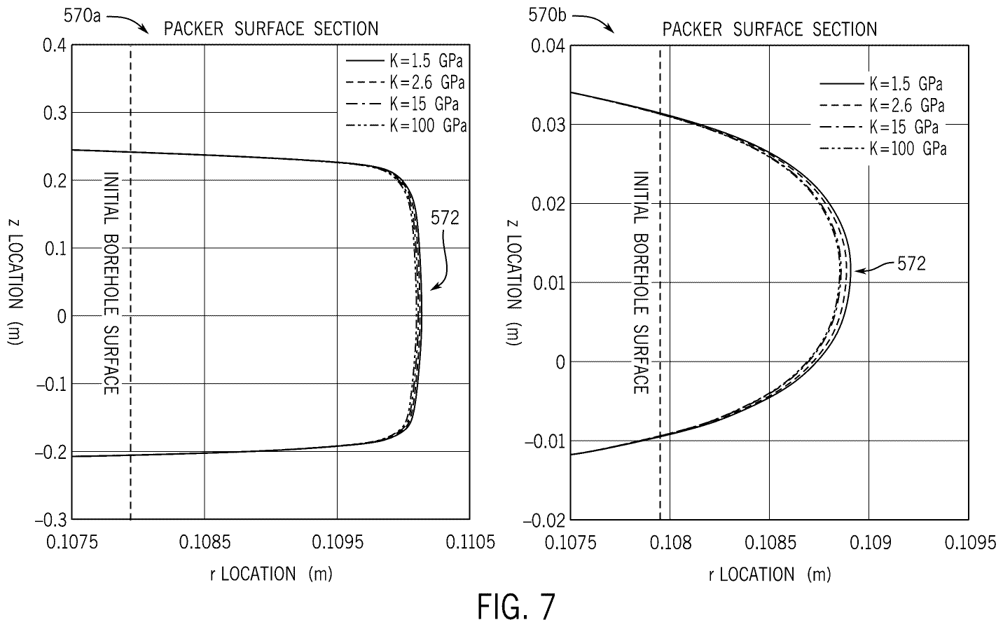

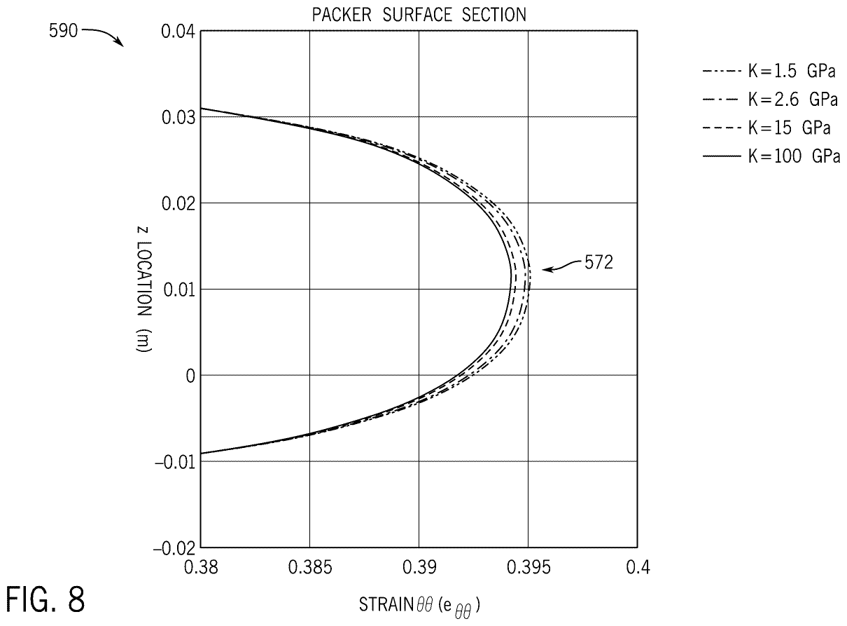

This lack of sensitivity to K is again highlighted in graph 570a of FIG. 7. In this case, G was set to 2 GPa and K was varied over 2 orders of magnitude. The packer displaces the formation by about 2 mm. The amount of displacement is almost unaffected by K. However, small differences in this displacement can be seen when the length of the packer 106 is reduced by a factor of 4 as shown in graph 570b of FIG. 7. These differences span a range of about 0.1 mm at the leading edge 572 of the packer 106. The corresponding circumferential strain, e_{θθ}, on the outer surface of the quarter-length packer 106 is shown in graph 590 of FIG. 8. As K changes from 1.5 GPa to 15 GPa, e_{θθ} varies over a range of about 0.1 millistrain at the leading edge 572 of the packer 106. Much smaller changes in e_{θθ} occur as K is increased beyond 15 GPa.

The results shown in FIGS. 7 and 8 suggest that K could be inferred by making precise strain or displacement measurements at suitable locations on the packer 106. For example, to determine the level of accuracy that might be appropriate for strain measurements, a large variety of cases of K and G were simulated for the quarter-length packer 106. For each case, the stabilized slopes dV/dP and de_{θθ}/dP were extracted, where e_{θθ} was computed at the leading edge 572 of the packer 106.

The results are summarized in the contour plot of FIG. 9. FIG. 9 is an embodiment of a contour plot 600 (e.g., output on an electronic display of a computer system) of a plurality of contour lines 602 of the static bulk modulus (K) and a plurality of contour lines 604 of the static shear modulus (G) as a function of a first derivative (de_{θθ}/dP) along a Y-axis 606 versus a second derivative (dV/dP) along an X-axis 608. The contour plot 600 is generated based on a plurality of computer simulations using a computer model of the geological formation, the borehole, and the packer 106. The computer model may receive inputs of G, K, pressure (P) in the packer 106, volume (V) in the packer 106, a borehole geometry (e.g., borehole diameter), and one or more additional inputs. As illustrated, each of the plurality of contour lines 602 represents a constant value of the static bulk modulus (K), and each of the plurality of contour lines 604 represents a constant value of the static shear modulus (G) for various values of the first and second derivatives and other inputs. Thus, once the computer simulation is complete for the various contour lines 602 and 604, the values of the static bulk modulus (K) and the static shear modulus (G) can be determined with relatively good accuracy by reading the K and G values from the graph. This procedure is known as graphical inversion. Alternatively, the values of G and K can be calculated using a computer algorithm that searches for the values of G and K that best match measured data (dV/dP, de_{θθ}/dP). This procedure is called numerical inversion. For example, as discussed below, the graphical inversion process may identify the static bulk modulus (K) and the static shear modulus (G) by graphically pinpointing a location 610 for the first and second derivatives 612 and 614 or a location 616 for the first and second derivatives 618 and 620.

Thus, the embodiments disclosed herein may perform the inversion to identify the static bulk modulus (K) and the static shear modulus (G) with or without the contour plot 600. In the illustrated embodiment, if dV/dP and de_{θθ}/dP are measured during the pressuremeter test, this plot may be used to estimate both K and G. The plot shows that contours of constant G are almost vertical implying that G may be determined from knowledge of dV/dP alone, as expected. However, the static bulk modulus (K) may be estimated if both dV/dP and de_{θθ}/dP are known. Moreover, the resolution of K depends on its magnitude. For example, if dV/dP=0.4 cc/MPa as illustrated by line 614 and de_{θθ}/dP=38 μStrain/MPa as illustrated by line 612, the corresponding values of K and G are approximately 15 GPa and 7.5 GPa respectively.

Most notably, the static bulk modulus (K) can be resolved to within about 3 GPa if de_{θθ}/dP is known to within about 0.5 μStrain/MPa. This implies that if the slope de_{θθ}/dP is evaluated over a pressure range of 10 MPa, the strain measurement needs to have an accuracy superior to 5 μStrain. Conversely, if dV/dP=0.455 cc/MPa as illustrated by line 620 and de_{θθ}/dP=40 μStrain/MPa as illustrated by line 618, the corresponding values of K and G are approximately 32.5 GPa and 6.6 GPa respectively. However, the static bulk modulus (K) may be anywhere between 25 GPa and 40 GPa, if the error in de_{θθ}/dP is ±0.5 μStrain/MPa. Therefore, the resolution of K decreases as K increases. One strategy to maintain resolution at higher values of K is to reduce the error in de_{θθ}/dP by increasing the range of pressures over which de_{θθ}/dP is evaluated. Assuming that the error in the strain measurement is fixed (e.g. ±1 μStrain), the error in the gradient de_{θθ}/dP will be inversely proportional to the range of pressures over which de_{θθ}/dP is evaluated. In general, maintaining resolution at higher values of K involves either (a) higher accuracy measurements, (b) a larger number or variety of measurements (as discussed in relation to FIG. 11), or (c) exposure of the formation to a larger range of pressures.

The presently described embodiments use high precision strain, stress, or displacement measurements to infer the static bulk modulus (K) of a soil or rock formation. In some embodiments, a relatively short pressuremeter (L/D ratio<1) may be advantageous for enhancing measurement sensitivity; however, a variety of L/D ratios may be used with the presently described embodiments. The presently described embodiments are not restricted in scope to the particular measurements shown in the example of FIG. 9. Those of ordinary skill will recognize that the inference of K could be based on measurements made at other locations within the pressuremeter device besides its leading edge 134. Measurements may also be made of the depression in the wellbore wall produced by contact with the packer 106 by for example, attaching a strain gauge to the borehole wall itself or using calipers or clamps, as discussed in relation to FIG. 3. Gradients such as dV/dP and de_{θθ}/dP could be inverted, but so too could original curves (P versus V, see versus P, etc.). The inversion does not have to be based solely on data from regions where slopes have stabilized. Inversion techniques could be graphical, as in the example of FIG. 9, but may also be numerical (deterministic or stochastic). The forward model used in the inversion may be based on a variety of constitutive models or numerical methods such as elastic, hyperelastic, viscoplastic, finite elements, finite differences, analytical or semi-analytical techniques. They may include sophisticated models of the packer 106 and its contact with the borehole wall 138.

A variety of devices exist for performing high-precision strain and displacements measurements. For example, strain gauges, strain rings, strain sheets or fiber optic cables could be embedded in the packer 106. Calipers or digital micro-optical cameras could be installed inside or outside the packer 106. Alternatively, stresses within the packer 106 membrane could be computed instead of strains, thereby allowing for pressure or stress sensing elements to be embedded inside the packer. The sensors 124 and 126 may be used for the various measurements, as discussed in detail above.

FIG. 10 is an embodiment of a contour plot 650 (e.g., output on an electronic display of a computer system) of a plurality of contour lines 652 of a first derivative (dε_{zz}/dP) and a plurality of contour lines 654 of a second derivative (dP/dV) as a function of the static bulk modulus (K) along a Y-axis 656 versus the static shear modulus (G) along an X-axis 658. In the illustrated embodiment, the contour plot 650 includes a contour plot 650a over a larger range of K and G values along the Y-axis 656 and the X-axis 658, whereas a contour plot 650b represents a zoomed in portion taken within a window 650c of the contour plot 650a. Thus, the contour lines 650a and 650b are discussed together as the contour plot 650. The contour plot 650 is generated based on a plurality of computer simulations using a computer model of the geological formation, the borehole, and the packer 106. The computer model may receive inputs of G, K, pressure (P) in the packer 106, volume (V) in the packer 106, a borehole geometry (e.g., borehole diameter), and one or more additional inputs. As illustrated, each of the plurality of contour lines 652 represents a constant value of the first derivative (dε_{zz}/dP), and each of the plurality of contour lines 654 represents a constant value of the second derivative (dP/dV) for various values of the static bulk modulus (K), the static shear modulus (G), and other inputs.

Thus, once the computer simulation is complete for the various contour lines 652 and 654, the values of the static bulk modulus (K) and the static shear modulus (G) can be determined with relatively good accuracy either by a graphical inversion process and/or a computer inversion process based on the current measurements of first and second derivatives. For example, the accuracy of the determinations of K and G depends on the proximity or spacing between the plurality of contour lines 652 and 654, as indicated by an error window 660 in the contour plot 650b. In certain embodiments, the graphical inversion process may identify the static bulk modulus (K) and the static shear modulus (G) by graphically pinpointing a location of the first and second derivatives and graphically following the location to the Y-axis 656 to determine the K value and graphically following the location to the X-axis 658 to determine the G value. Similarly, the system may perform a numerical inversion whereby the values of G and K can be calculated using a computer algorithm that searches for the values of G and K that best match measured values of the two derivatives. Thus, the embodiments disclosed herein may perform the inversion to identify the static bulk modulus (K) and the static shear modulus (G) with or without the contour plot 650.

The derivative of axial strain with respect to the pressure (dε_{zz}/dP) (μStrain/MPa) for the sensors above the packer 106 and/or below the packer 106 and the derivative of the pressure with respect to the volume (dP/dV) (MPa/cc) are both graphed after being output from a computer simulation. Any of the other derivatives discussed previously may also be plotted. In order to assess the resolution with which K and G could be inferred, 650b shows a zoomed-in section of the contour plot of 650a with values of contours that represent resolutions typical of high precision sensors. The user or system may locate the applicable contour lines of dε_{zz}/dP and dP/dV for the relevant location in the borehole 104. For example, in the illustrated embodiment, if the measured value of dε_{zz}/dP was 3.05 μStrain/MPa and the value of dP/dV was 0.855, the K value and G value would fall in a window 662, which is defined by points 664, 666, 668, and 670. To determine the potential range of values for K, the user or system may look at the largest and smallest Y coordinate of the points 664, 666, 668, and 670 along the Y-axis 656. As such, in the illustrated embodiment, the user or system may utilize point 664 for the largest Y value and point 668 for the smallest Y value. As such, the Y values, and resulting K values, in the illustrated embodiment may range from 35 GPa to 39 GPa. Similarly, to determine the potential range of values for G, the user or system may look at the largest and smallest X coordinate of the points 664, 666, 668, and 670 along the X-axis 658. As such, the X values, and resulting G values, in the illustrated embodiment may range from approximately 11.6 GPa to 11.75 GPa.

FIG. 11 illustrates a series of inverted contour plots 700a, 700b, 700c, 700d, which may be stacked to more precisely estimate K and G. In the illustrated embodiment, K (GPa) is graphed on the Y-axis 656 and G (GPa) is graphed on the X-axis 658. The contour plots 700a, 700b, 700c, 700d are generated based on a plurality of computer simulations using a computer model of the geological formation, the borehole, and the packer 106. The computer model may receive inputs of G, K, pressure (P) in the packer 106, volume (V) in the packer 106, a borehole geometry (e.g., borehole diameter), and one or more additional inputs. As illustrated, each of the contour plots 700a, 700b, 700c, 700d includes a plurality of contour lines, each having a constant value of a particular derivative. Thus, once the computer simulation is complete for the various contour lines, the values of the static bulk modulus (K) and the static shear modulus (G) can be determined with relatively good accuracy by reading them from the graph as shown in the contour plots 700a, 700b, 700c, and 700d. Alternatively, the system may perform a numerical inversion of the measured derivatives. It should be noted that point 702a, point 702b, point 702c, and point 702d may represent the same point on different contour plots and overlays.

Plot 700a illustrates a contour plot having a plurality of contour lines 701 of the derivative of the pressure with respect to the volume (dP/dV) (MPa/cc). The point 702a represents the real values of K and G of a given geological formation while the shaded region shows the range of possible values of K and G that can be inferred from typical high-precision measurements of dP/dV. Plot 700b illustrates a contour plot having a plurality of contour lines 703 of the derivative of the axial strain with respect to the pressure (dε_{zz}/dP) (μStrain/MPa) for the sensors above the packer 106 and a plurality of contour lines 705 of the derivative of the tilt with respect to the volume (de/dV) (arcSec/cc) for the sensors above the packer 106. Points 704, 706, 708, and 710 are vertices of the feasible region of K and G that may be inferred from typical high-precision sensors. This section is determined by point 702b, the coordinates of which are determined by the applicable derivatives dε_{zz}/dP and de/dV for the location in the borehole 104. In the illustrated embodiment, the K may lie between 33 GPa and 36.5 GPa.

Plot 700c illustrates a contour plot having a plurality of contour lines 707 of the derivative of the axial strain with respect to the pressure (dε_{zz}/dP) (u Strain/MPa) for the sensors below the packer 106 and a plurality of contour lines 709 of the derivative of the tilt with respect to the volume (de/dV) (arcSec/cc) for the sensors below the packer 106. The extensometer 310 may be deliberately offset a distance of 5 cm below the packer to supplement data obtained from the sensors at the top of the packer. Points 716, 718, and 720 are vertices of the feasible region of K and G that could be inferred from typical high-precision sensors. This section is determined by point 702c, the coordinates of which are determined by the applicable derivative dε_{zz}/dP and dθ/dV for the location in the borehole 104. In the illustrated embodiment, the K value may lie between 31 GPa and 36 GPa.

Plot 700d illustrates a contour plot having the plots 700a, 700b, and 700c stacked upon one another. In particular the plot 700d illustrates a contour plot having the plurality of contour lines 707 of the derivative of the axial strain with respect to the pressure (dε_{zz}/dP) (μStrain/MPa) for the sensors below the packer 106, the plurality of contour lines 703 of the derivative of the axial strain with respect to the pressure (dε_{zz}/dP) (μStrain/MPa) for the sensors above the packer 106, the plurality of contour lines 705 and 709 of the derivative of the tilt with respect to the volume (de/dV) (arcSec/cc) for the sensors above the packer 106 and below the packer 106, and the plurality of contour lines 701 of the derivative of the pressure with respect to the volume (dP/dV) (MPa/cc). Points 724, 726, 728, and 730 are vertices of the feasible region of G and K, accounting for the resolutions of all the measurements shown in Plots 700a, 700b and 700c. This section is determined by point 702d, the coordinates of which are determined by the applicable derivative dε_{zz}/dP and de/dV for the location in the borehole 104. In the illustrated embodiment, the K value for plot 700d may lie between 33 GPa and 36 GPa. Thus, joint inversion of data from multiple sensors above and below the packer 106 may improve the resolution of K. Adding additional measurements may increase the resolution of K values by further limiting the size of the region 732.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

Technical effects of the disclosed embodiments enable a determination of both the shear bulk modulus (G) and the static bulk modulus (K) via a plurality of computer simulations of various derivatives. Thus, the static bulk modulus (K) can be determined based on measurements acquired on-site at a wireline formation tester (WFT) tool in a borehole in a relatively short amount of time, rather than a delayed result obtained from rock samples taken offsite for determination of the static bulk modulus (K). Accordingly, the static bulk modulus (K) may be determined in real-time via numerical inversion and/or substantially in real-time via graphical inversion using user input associated with contour plots displayed on an electronic display. In either case, the disclosed embodiments enable relatively fast determination of the static bulk modulus (K) compared to conventional techniques of rock sample analyses, thereby helping to improve the efficiency of oil and gas operations at a wellsite.

The subject matter described in detail above may be defined by one or more clauses, as set forth below.

A method for estimation of static bulk modulus, K of a rock using a pressuremeter test, wherein the pressuremeter test measures one or more parameters of packers or a borehole in addition to a standard pressure-volume response.

The method of the preceding clause, wherein the one or more parameters are selected from the group consisting of internal or external radii, strain, stress, or displacement.

The method of any preceding clause, wherein the packers include a length to diameter ratio of <1.

The method of any preceding clause, wherein the packers include one or more devices for performing measurements of the one of more parameters.

The method of any preceding clause, wherein the one or more devices are selected from the group consisting of strain gages, strain rings, strain sheets, fiber optic cables, or a combination thereof.

A system for autonomous restriction navigation comprising, the system including a processor, memory accessible to the processor, and processor-executable instructions stored in the memory and executable by the processor to instruct the system to estimate static bulk modulus, K of a rock using a pressuremeter test, wherein the pressuremeter test measures one or more parameters of packers or a borehole in addition to a standard pressure-volume response.

The system of the preceding clause, wherein the one or more parameters are selected from the group consisting of internal or external radii, strain, stress, or displacement.

The system of any preceding clause, wherein the packers include a length to diameter ratio of <1.

The system of any preceding clause, wherein the packers include one or more devices for performing measurements of the one of more parameters.

The system of any preceding clause, wherein the one or more devices are selected from the group consisting of strain gages, strain rings, strain sheets, fiber optic cables, or a combination thereof.

A method including obtaining measurements of one or more first parameters of a packer during an actuation of the packer in a borehole, obtaining measurements of one or more second parameters related to a geometrical change in the borehole caused by the actuation of the packer, and analyzing a plurality of first and second parameters, a plurality of derivatives of the first and second parameters, or a combination thereof to estimate at least a static bulk modulus (K) of a geological formation surrounding the borehole.

The method of the preceding clause, wherein the one or more first parameters include at least a pressure and a volume of the packer during the actuation of the packer.

The method of any preceding clause, wherein the one or more second parameters comprise at least one of a radius, a tilt angle, a stress, a strain, a displacement, or any combination thereof.

The method of any preceding clause, wherein the plurality of derivatives comprises a derivative of strain with respect to pressure, a derivative of tilt angle with respect to volume, or a combination thereof.

The method of any preceding clause, wherein the plurality of derivatives comprises a derivative of volume with respect to pressure.

The method of any preceding clause, including deploying a test tool into the borehole, wherein the test tool includes the packer and a plurality of sensors configured to measure the one or more first parameters and the one or more second parameters, controlling the actuation of the packer, and acquiring the measurements of the one or more first parameters and the one or more second parameters via the sensors.

The method of the preceding clause, wherein the plurality of sensors includes one or more first sensors and one or more second sensors, the one or more first sensors are coupled to the packer, and the one or more second sensors are coupled to the packer, separate from the packer, or a combination thereof.

The method of the preceding clause, wherein analyzing further includes analyzing the plurality of derivatives associated with the first and second parameters further to estimate a static shear modulus (G) of the geological formation surrounding the borehole.

The method of the preceding clause, including building or updating a mechanical earth model (MEM) based on the static bulk modulus (K) and the static shear modulus (G).

The method of any preceding clause, including controlling one or more parameters of a hydrocarbon extraction system based on the static bulk modulus (K), wherein analyzing the plurality of derivatives to estimate at least the static bulk modulus (K) is performed in real-time upon obtaining the measurements of the one or more first parameters and the one or more second parameters.

The method of any preceding clause, wherein analyzing the plurality of derivatives comprises comparing the plurality of derivatives against the plurality of derivatives output from a computer simulation of the actuation of the packer and the geometrical change in the borehole.

The method of any preceding clause, wherein analyzing the plurality of derivatives comprises comparing one or more pairs of derivatives to the plurality of derivatives output from the computer simulation.

The method of any preceding clause, wherein analyzing the plurality of derivatives comprises outputting one or more contour plots on an electronic display illustrating a relationship between the plurality of derivatives and at least the static bulk modulus (K) based on the computer simulation.

The method of any preceding clause, wherein the packer comprises a length to diameter ratio of less than 1.

A tangible and non-transitory machine readable medium including instructions executable by one or more processors to perform operations including obtaining measurements of one or more first parameters of a packer during an actuation of the packer in a borehole, obtaining measurements of one or more second parameters indicative of a geometrical change in the borehole caused by the actuation of the packer, and analyzing a plurality of first and second parameters, derivatives based on the plurality of first and second parameters, or a combination thereof to estimate at least a static bulk modulus (K) of a geological formation surrounding the borehole.

The medium of the preceding clause, wherein analyzing the plurality of derivatives comprises comparing the plurality of derivatives against the plurality of derivatives output by a computer simulation of the actuation of the packer and the geometrical change in the borehole, wherein the computer simulation provides a relationship between the plurality of derivatives and at least the static bulk modulus (K) and a static shear modulus (G).

The medium of the preceding clause, wherein analyzing the plurality of derivatives comprises outputting one or more contour plots on an electronic display illustrating the relationship between the plurality of derivatives and at least the static bulk modulus (K) and the static shear modulus (G) based on the computer simulation.

A system including a test tool configured to deploy into a borehole. The test tool includes a packer, a plurality of sensors, and a controller having a processor, a memory, and instructions stored on the memory and executable by the processor. The controller performs operations including obtaining measurements of one or more first parameters of the packer during an actuation of the packer in the borehole via one or more first sensors of the plurality of sensors. The controller also performs operations including obtaining measurements of one or more second parameters indicative of a geometrical change in the borehole caused by the actuation of the packer via one or more second sensors of the plurality of sensors. The controller also performs operations including analyzing a plurality of first and second parameters, derivatives based on the plurality of first and second parameters, or a combination thereof to estimate at least a static bulk modulus (K) of a geological formation surrounding the borehole locally on the controller and/or remotely on a computer separate from the test tool.

The system of the preceding clause, wherein the one or more first parameters include at least a pressure and a volume of the packer during the actuation of the packer, and the one or more second parameters comprise at least one of a radius, a tilt angle, a stress, a strain, a displacement, or any combination thereof.

The system of any preceding clause, wherein the one or more second sensors comprise one or more strain gauges, strain rings, strain sheets, piezo sensors, sonic and ultrasonic sensors, fiber optic cables, extensometers, tiltmeters, calipers, or a combination thereof.

While only certain features have been illustrated and described herein, many modifications and changes will occur to those skilled in the art. It is, therefore, to be understood that the appended claims are intended to cover all such modifications and changes as fall within the true spirit of the disclosure. The techniques presented and claimed herein are referenced and applied to material objects and concrete examples of a practical nature that demonstrably improve the present technical field and, as such, are not abstract, intangible or purely theoretical.

1. A method, comprising:
obtaining measurements of one or more first parameters of a packer during an actuation of the packer in a borehole;
obtaining measurements of one or more second parameters related to a geometrical change in the borehole caused by the actuation of the packer; and
analyzing a plurality of first and second parameters, a plurality of derivatives of the first and second parameters, or a combination thereof to estimate at least a static bulk modulus (K) of a geological formation surrounding the borehole.

2. The method of claim 1, wherein the one or more first parameters comprises at least a pressure and a volume of the packer during the actuation of the packer.

3. The method of claim 2, wherein the one or more second parameters comprise at least one of a radius, a tilt angle, a stress, a strain, a displacement, or any combination thereof.

4. The method of claim 3, wherein the plurality of derivatives comprises a derivative of strain with respect to pressure, a derivative of tilt angle with respect to volume, or a combination thereof.

5. The method of claim 4, wherein the plurality of derivatives comprises a derivative of volume with respect to pressure.

6. The method of claim 1, comprising:
deploying a test tool into the borehole, wherein the test tool comprises the packer and a plurality of sensors configured to measure the one or more first parameters and the one or more second parameters;
controlling the actuation of the packer; and
acquiring the measurements of the one or more first parameters and the one or more second parameters via the sensors.

7. The method of claim 6, wherein the plurality of sensors comprise one or more first sensors and one or more second sensors, the one or more first sensors are coupled to the packer, and the one or more second sensors are coupled to the packer, separate from the packer, or a combination thereof.

8. The method of claim 1, wherein analyzing further comprises analyzing the plurality of derivatives associated with the first and second parameters further to estimate a static shear modulus (G) of the geological formation surrounding the borehole.

9. The method of claim 8, comprising building or updating a mechanical earth model (MEM) based on the static bulk modulus (K) and the static shear modulus (G).

10. The method of claim 1, comprising controlling one or more parameters of a hydrocarbon extraction system based on the static bulk modulus (K), wherein analyzing the plurality of derivatives to estimate at least the static bulk modulus (K) is performed in real-time upon obtaining the measurements of the one or more first parameters and the one or more second parameters.

11. The method of claim 1, wherein analyzing the plurality of derivatives comprises comparing the plurality of derivatives against the plurality of derivatives output from a computer simulation of the actuation of the packer and the geometrical change in the borehole.

12. The method of claim 11, wherein analyzing the plurality of derivatives comprises comparing one or more pairs of derivatives to the plurality of derivatives output from the computer simulation.

13. The method of claim 11, wherein analyzing the plurality of derivatives comprises outputting one or more contour plots on an electronic display illustrating a relationship between the plurality of derivatives and at least the static bulk modulus (K) based on the computer simulation.

14. The method of claim 1, wherein the packer comprises a length to diameter ratio of less than 1.

15. A tangible and non-transitory machine readable medium comprising instructions executable by one or more processors to perform operations comprising:
obtaining measurements of one or more first parameters of a packer during an actuation of the packer in a borehole;
obtaining measurements of one or more second parameters indicative of a geometrical change in the borehole caused by the actuation of the packer; and
analyzing a plurality of first and second parameters, derivatives based on the plurality of first and second parameters, or a combination thereof to estimate at least a static bulk modulus (K) of a geological formation surrounding the borehole.

16. The medium of claim 15, wherein analyzing the plurality of derivatives comprises comparing the plurality of derivatives against the plurality of derivatives output by a computer simulation of the actuation of the packer and the geometrical change in the borehole, wherein the computer simulation provides a relationship between the plurality of derivatives and at least the static bulk modulus (K) and a static shear modulus (G).

17. The medium of claim 16, wherein analyzing the plurality of derivatives comprises outputting one or more contour plots on an electronic display illustrating the relationship between the plurality of derivatives and at least the static bulk modulus (K) and the static shear modulus (G) based on the computer simulation.

18. A system, comprising:
a test tool configured to deploy into a borehole, wherein the test tool comprises:
a packer;
a plurality of sensors; and
a controller having a processor, a memory, and instructions stored on the memory and executable by the processor to perform operations comprising:
obtaining measurements of one or more first parameters of the packer during an actuation of the packer in the borehole via one or more first sensors of the plurality of sensors;
obtaining measurements of one or more second parameters indicative of a geometrical change in the borehole caused by the actuation of the packer via one or more second sensors of the plurality of sensors; and
analyzing a plurality of first and second parameters, derivatives based on the plurality of first and second parameters, or a combination thereof to estimate at least a static bulk modulus (K) of a geological formation surrounding the borehole locally on the controller and/or remotely on a computer separate from the test tool.

19. The system of claim 18, wherein the one or more first parameters comprises at least a pressure and a volume of the packer during the actuation of the packer, and the one or more second parameters comprise at least one of a radius, a tilt angle, a stress, a strain, a displacement, or any combination thereof.

20. The system of claim 18, wherein the one or more second sensors comprise one or more strain gauges, strain rings, strain sheets, piezo sensors, sonic and ultrasonic sensors, fiber optic cables, extensometers, tiltmeters, calipers, or a combination thereof.
